(19) United States
(12) Patent Application Publication
(10) Pub. No.: US 2016/0132201 A1
(43) Pub. Date: May 12, 2016

(54) CONTEXTUAL TABS IN MOBILE RIBBONS

(71) Applicant: Microsoft Technology Licensing, LLC, Redmond, WA (US)

(72) Inventors: Han-Yi Shaw, Redmond, WA (US); Chris R. Livdahl, Seattle, WA (US); Derek V. Snook, Redmond, WA (US)

(21) Appl. No.: 14/685,688

(22) Filed: Apr. 14, 2015

Related U.S. Application Data
(60) Provisional application No. 62/076,250, filed on Nov. 6, 2014.

(51) Int. Cl. G06F 3/0483; G06F 3/0484; G06F 3/0482

(52) U.S. Cl. CPC G06F 3/0483; G06F 3/0482; G06F 3/04842

(57) ABSTRACT

Disclosed herein are systems, methods, and software that enhance the content viewing experience on computing devices. In an implementation, an application presents a user interface that comprises a canvas and a navigation element. When selected, that navigation element surfaces a navigation menu that includes various menu elements selectable to navigate to corresponding feature menus. The application monitors for activity in the user interface that affects a presence in the menu elements of a contextual menu element for navigating to a contextual feature menu. When the activity occurs, the application modifies an appearance of the navigation element to indicate the presence of the contextual menu element.

### RELATED APPLICATIONS

This application is related to and claims priority to U.S. Provisional Application No. 62/076,250, filed on Nov. 6, 2014, and entitled “Contextual Tabs in Mobile Ribbons,” which is hereby incorporated by reference in its entirety.

### TECHNICAL BACKGROUND

A feature found in some document productivity applications is the ribbon tool bar. The ribbon tool bar provides users access to many features and functions of the applications. In some cases, the ribbon is contextual in that the features found under a given tab in the ribbon may change based on the situational context.

In the desktop computing space, most of, if not all of, the tabs in a ribbon are visible to a user at once. In the mobile space, where smaller form factors dominate, it is sometimes not possible to display all of the tabs of a ribbon at once due to the limited visual space that is available on smaller form-factor screens.

### OVERVIEW

Provided herein are systems, methods, and software that enhance the user interface experience on computing devices having small form factors relative to larger devices, although such enhancements are applicable to devices of any form factor. In an implementation, an application surfaces a bump animation to indicate the presence of a contextual tab in a ribbon. The ribbon is representative of a navigation menu while the bump animation is representative of a modification to the appearance of a navigation element.

In addition, when any tab is selected that is contextual, the application surfaces another bump animation to indicate that the tab is contextual. In this manner, an end user may be made aware that a contextual tab is present in a ribbon and, when one is selected, the user is reminded that it is contextual.

In at least one other implementation, an application presents a user interface that comprises a canvas and a navigation element. When selected, that navigation element surfaces a navigation menu that includes various menu elements selectable to navigate to corresponding feature menus. The application monitors for activity in the user interface that affects a presence in the menu elements of a contextual menu element for navigating to a contextual feature menu. When the activity occurs, the application modifies an appearance of the navigation element to indicate the presence of the contextual menu element.

This Overview is provided to introduce a selection of concepts in a simplified format that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates enhanced user interface technology employed in an implementation to render various views of a user interface.

FIG. 2 illustrates a user interface process in an implementation.

FIGS. 3A-3C illustrate various user interface progressions in an implementation of enhanced user interface technology.

FIG. 4 illustrates a user interface progression in an implementation of enhanced user interface technology.

FIGS. 5A-5C illustrate various user interface progressions in an implementation of enhanced user interface technology.

FIG. 6 illustrates a user interface progression in an implementation.

FIG. 7 illustrates a user interface process in an implementation.

FIG. 8 illustrates a computing system suitable for implementing any of the applications, architectures, services, processes, and operational scenarios disclosed herein with respect to FIGS. 1-8 and discussed below in the Technical Disclosure.

### TECHNICAL DISCLOSURE

Implementations disclosed herein illustrate various user interfaces in which users are alerted to the presence of a contextual menu item that is off-screen by changing the appearance of an element on-screen. The appearance of the element may be changed in a manner that attracts the user's attention, but that is subtle enough to not distract.

In one example, a home button is displayed in a user interface that, when selected, leads to a home menu from where a user can navigate to other sub-menus. When activity occurs in the user interface that affects the presence of a contextual tab in the home menu, the appearance of the home button is modified to signal this change, even though the home menu may not yet be visible in the user interface. The bump animation informs the user that a contextual menu is enabled and can be reached through the home button.

A contextual menu element is an element whose presence in a menu depends on an operating context at the time when a user navigates to the menu. A non-contextual menu is an element whose presence in the menu does not depend on the surrounding context.

A table tab in a ribbon tool bar that leads to controls for formatting a table is an example of a contextual menu item, as its presence in a menu depends on whether or not a table is selected in the user interface. A home tab in a ribbon tool bar is an example of a non-contextual menu item because its presence does not depend on the surrounding context. Other types or styles of tool bars may be considered within the scope of the disclosure, in addition to or other than ribbon tool bars, such as tool bars in the classic style.

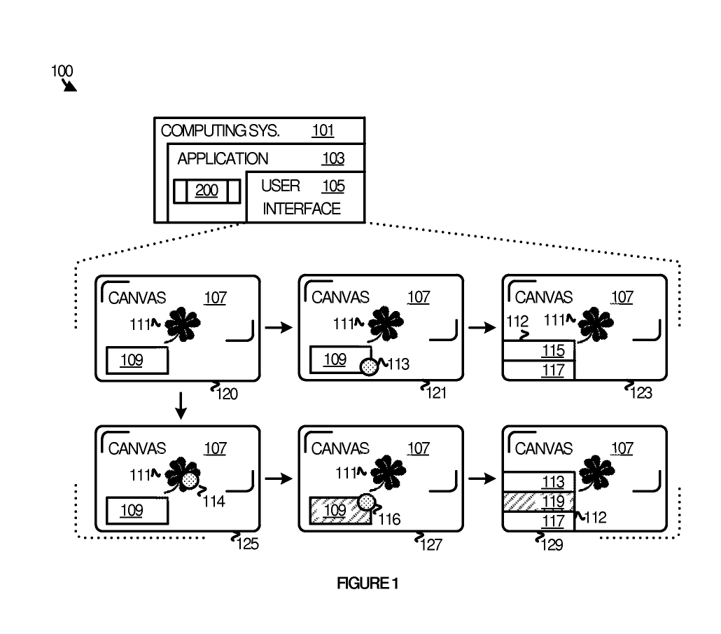

FIG. 1 illustrates an implementation 100 of enhanced user interface technology. Implementation 100 includes computing system 101. Application 103 resides on computing system 101 and is executed to render user interface 105.

Computing system 101 is representative of any physical or virtual computing system, device, or collection thereof capable of hosting application 103 and implementing user interface process 200. Examples of computing system 101 include, but are not limited to, smart phones, laptop computers, tablet computers, desktop computers, hybrid computers, gaming machines, smart televisions, virtual machines, and wearable devices, as well as any variation or combination thereof, of which computing system 801 in FIG. 9 is representative.

Application 103 is representative of any software application capable of presenting user interface 105 and employing user interface process 200. Application 103 may be a stand-alone application or it may be implemented in a distributed manner as multiple applications. In addition, application 103 may be a natively installed application, a browser-based application that executes in the context of a browser, a streaming application, or any other type of application, including any combination or variation thereof. Examples include, but are not limited to, games, media players, app store applications, browsers, and productivity applications, such as word processing, spreadsheet, document editing, and presentation applications.

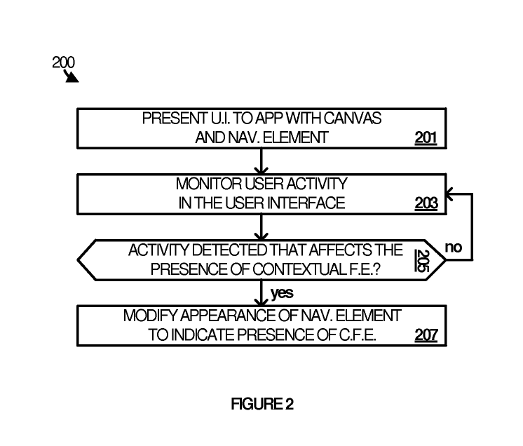

User interface process 200 is representative of any component, module, or other logic employed to drive various visual progressions in user interface 105. FIG. 2 illustrates the functional steps that may be carried out by application 103 (or any application) when executing user interface process 200.

Referring parenthetically to the steps illustrated in FIG. 2, an application employing user interface process 200 would present a user interface that includes a canvas and a navigation element (step 201). The application would also monitor user activity occurring in the user interface for any activity that may affect the presence (or lack thereof) of a contextual menu element in an off-screen navigation menu (step 203).

When such activity is detected (step 205), the application would modify the appearance of the navigation element in the user interface to indicate the presence of the contextual menu element in the navigation menu (step 207). If no such activity is detected, the application would continue its monitoring.

In some implementations, the activity that is detected may be followed by other activity that reverses the state of the contextual menu element. In other words, some activity may result in the presence of the contextual menu element in the navigation menu, while other activity that follows that activity removes the contextual menu element from the navigation menu. If and when such other activity occurs, the navigation element may be modified again to indicate that the contextual menu element is no longer included in the navigation menu. The appearance of the navigation element may be returned to its previous state for example.

Referring back to FIG. 1, various progressions in user interface 105 are illustrated to demonstrate an instance of user interface process 200 as employed by application 103 when rendering user interface 105. In its initial state 120, user interface 105 includes canvas 107 and navigation element 109. User interface 105 also includes content 111 rendered on canvas 107, which in this case is an image. Application 103 monitors user activity in user interface 105 for triggering activity as discussed above.

The state of user interface 105 progresses from initial state 120 to state 121 when user activity 113 occurs. User activity 113 in this progression is a selection of navigation element 109, such as a mouse click, a touch, a voice command, or some other user input. User activity 113 drives another state change in user interface 105 to state 123. However, the user activity in this progression is not activity that results in the presence of a contextual menu element in a navigation menu, and as such, the appearance of navigation element 109 is not modified. Rather, in state 123 a navigation menu 112 is surfaced that includes various menu elements represented by menu element 115 and menu element 117. Menu element 115 and menu element 117 may each be selected to navigate to a corresponding feature menu (not shown) that include various feature controls.

A different progression that may occur also starts with user interface 105 in its initial state 120. But instead of user activity 113 occurring, user interface 105 progress to a state 125 in which user activity 114 occurs that is representative of activity that changes the presence of a contextual menu element in navigation menu 112. In this example, user activity 114 is a selection of content 111, which may be accomplished by a touch, mouse click, spoken command, or the like. The selection of content 111 is representative of activity that results in the presence of a contextual menu element in navigation menu 112.

Accordingly, user interface 105 progress to another state 127 in which the appearance of navigation element 109 is modified relative to its appearance in state 125. The change in appearance is represented by the change in fill-pattern of navigation element 109, although many types of modifications are possible. For example, the size, shape, or color of navigation element 109 could change, an audible sound could be made, or the placement of navigation element 109 in user interface 105 could be changed. In one example, an animation of navigation element 109 may occur to draw a user's attention to the change, thereby notifying the user that a contextual menu element is available.

In this progression, navigation element 109 is selected by user activity 116, which drives a state change in user interface 105 to state 129. In state 129, navigation menu 112 is surfaced with a contextual menu element 119 present therein. In addition, contextual menu element 119 is surfaced in navigation menu 112 in such a manner that it is distinguishable from menu element 115 and menu element 117. For example, contextual menu element 119 may be surfaced with a color, shape, size, or fill pattern different from that of menu element 115 or menu element 117.

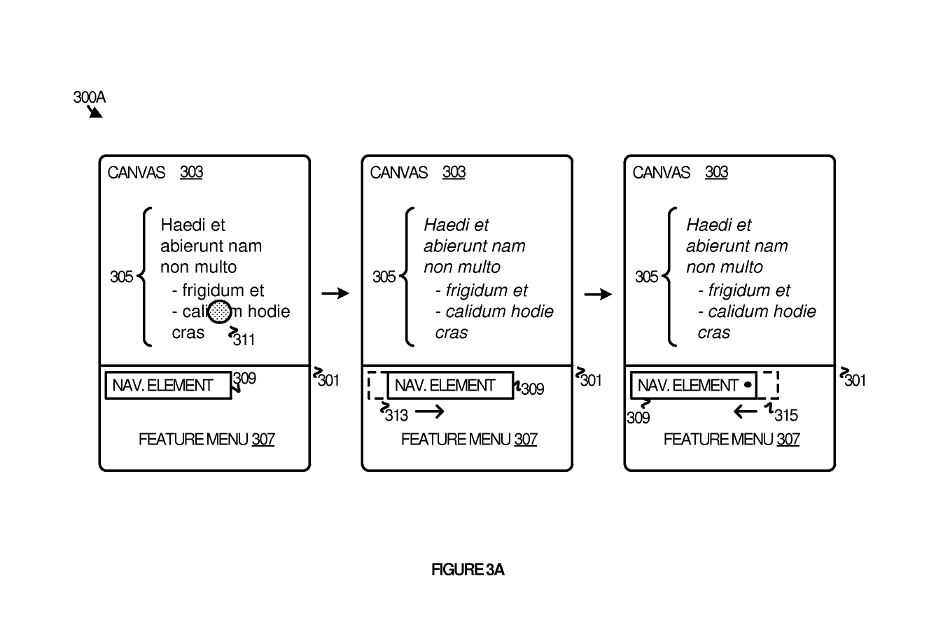

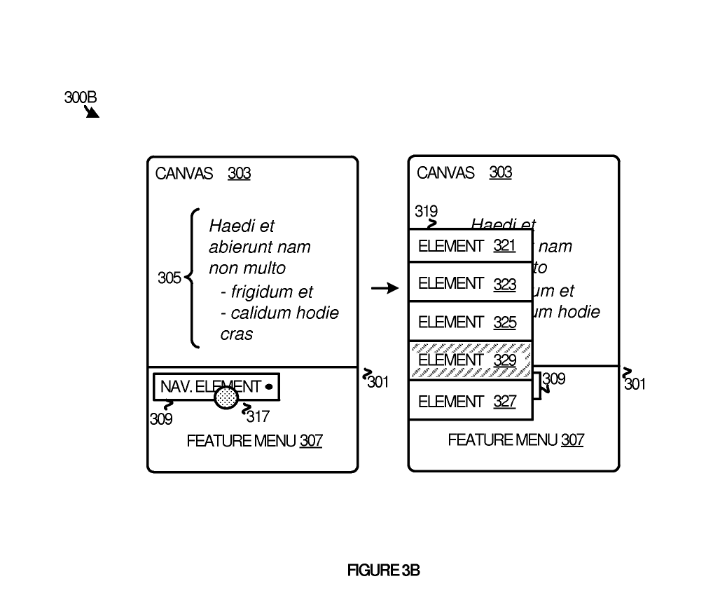

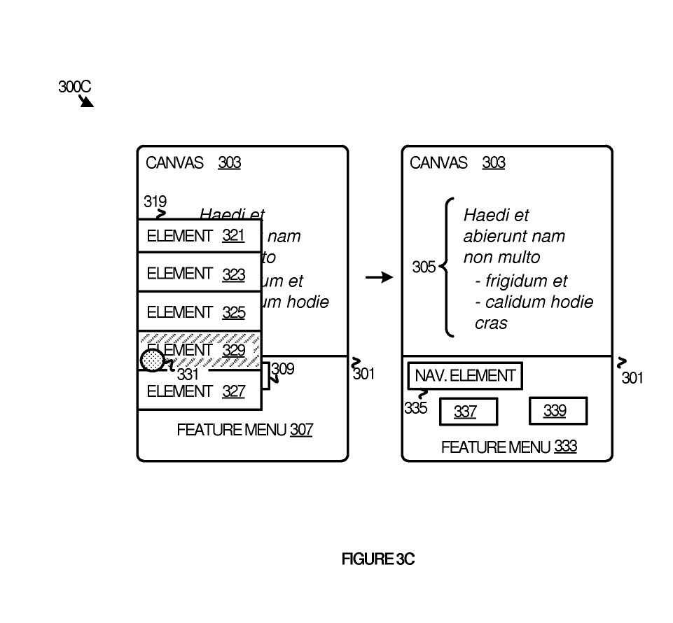

FIG. 3A illustrates another user interface progression 300A in an implementation. In user interface progression 300A, a user interface 301 includes a canvas 303, a feature menu 307, and a navigation element 309. Canvas 303 includes content 305 that has been created.

In operation, user activity 311 occurs that qualifies as activity that triggers the presence of a contextual menu element in a navigation menu. The appearance of navigation element 309 is modified in response to the activity in such a way as to draw attention to the element. In this example progression, a shift 313 of navigation element 309 is achieved in the horizontal direction, followed by a reverse shift 315 in the opposite direction. The combination of shift 313 and reverse shift 315, if executed rapidly enough, may give the visual impression of navigation element 309 being bumped out of user interface 301.

In addition to the bump-out animation, a static modification may be made to navigation element 309, which is represented by the solid dot that is rendered when navigation element 309 is shifted horizontally in one or the other directions. The dot provides an additional visual cue to the user that a contextual menu element is present in a navigation menu accessible via navigation element 309.

FIG. 3B illustrates another user interface progression 300B. User interface progression 300B may be a continuation of user interface progression 300A, although in some scenarios it may stem from other progressions that result in the presence of a contextual menu element in a navigation menu.

In operation, a selection 317 is made with respect to navigation element 309. Selecting navigation element 309 results in navigation menu 319 surfacing with various menu elements included therein, as well as at least one contextual menu element. The menu elements are represented by menu element 321, menu element 323, menu element 325, and menu element 327. The contextual menu element is represented by contextual menu element 329. In some implementations, but not all, contextual menu element 329 may be rendered with an appearance that distinguishes it from the other menu elements.

FIG. 3C illustrates user interface progression 300C. User interface progression 300C may be also be a continuation of user interface progression 300B, although in some scenarios it may continue from other progressions.

In operation, navigation menu 319 has been rendered as a result of a user selecting navigation element 309, at a time when a contextual menu element is present in navigation menu 319. A selection 331 is made with respect to contextual menu element 329. In response, user interface 301 transitions to a state that includes feature menu 333, which corresponds to contextual menu element 329. Had a different one of the elements in navigation menu 319 been selected, user interface 301 would have transitioned to a feature menu corresponding to that element.

Feature menu 333 includes various control elements that allow a user to apply features and controls of an application, at least one of which may be a contextual feature element. Control element 337 and control element 339 are representative of such elements. A contextual feature element is one that would not otherwise be present, enable, or otherwise available in a feature menu, depending upon the context or state of an application. Feature menu also includes navigation element 335. Selecting navigation element 335 surfaces navigation menu 319.

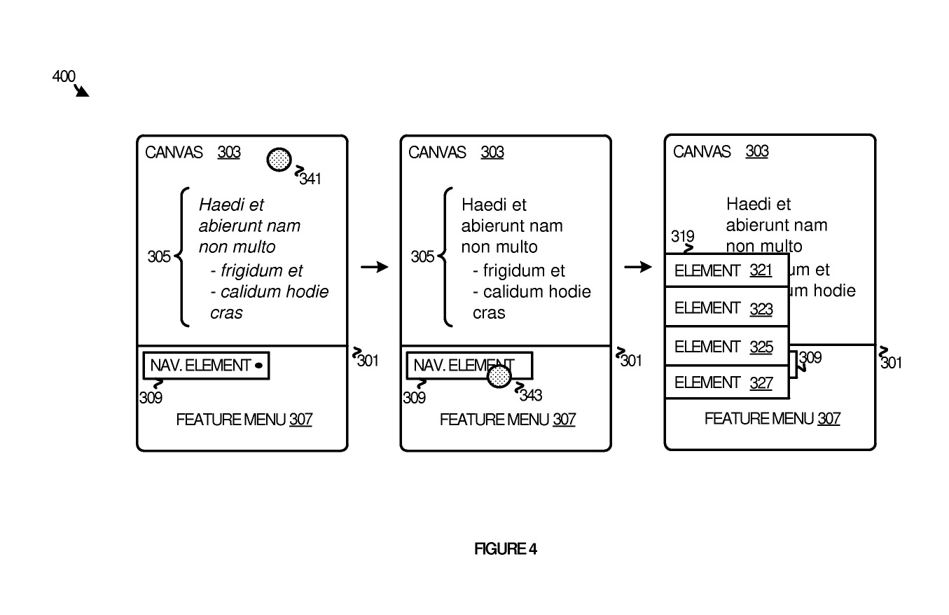

FIG. 4 illustrates still another user interface progression 400 in an implementation. In operation, user interface 301 is in a state representative of a state that may occur after an activity has occurred that causes a contextual menu element to be present in a navigation menu. Such a state is represented by the italicized font of content 305 as well as the presence of a visual dot in navigation element 309. In other words, user interface is in a state similar to the initial state of user interface 301 in FIG. 3B.

User activity 341 occurs in user interface 301 that does not affect the presence (or lack thereof) of a contextual menu element in a navigation menu. In fact, user activity 341 may be subsequent to triggering activity and as such change the state of user interface 301 from one in which a contextual menu element is available off-screen to one where the contextual menu element is no longer available.

To illustrate the change in state, content 305 is changed from an italicized style to a non-italicized style. As an example, a selection 343 is made with respect to navigation element 309 in user interface progression 400. The selection 343 causes user interface 301 to progress to a new state in which navigation menu 319 is again surfaced. However, in this state a contextual menu element is not present in navigation menu 319. This is because of the state or context of user interface 301 at the time selection 343 was made.

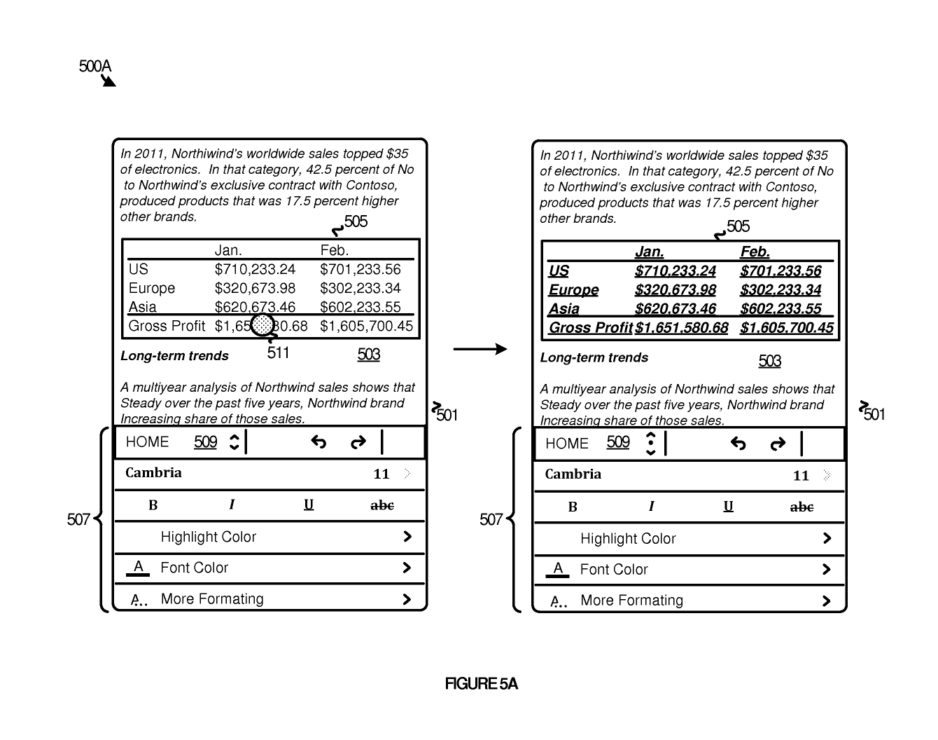

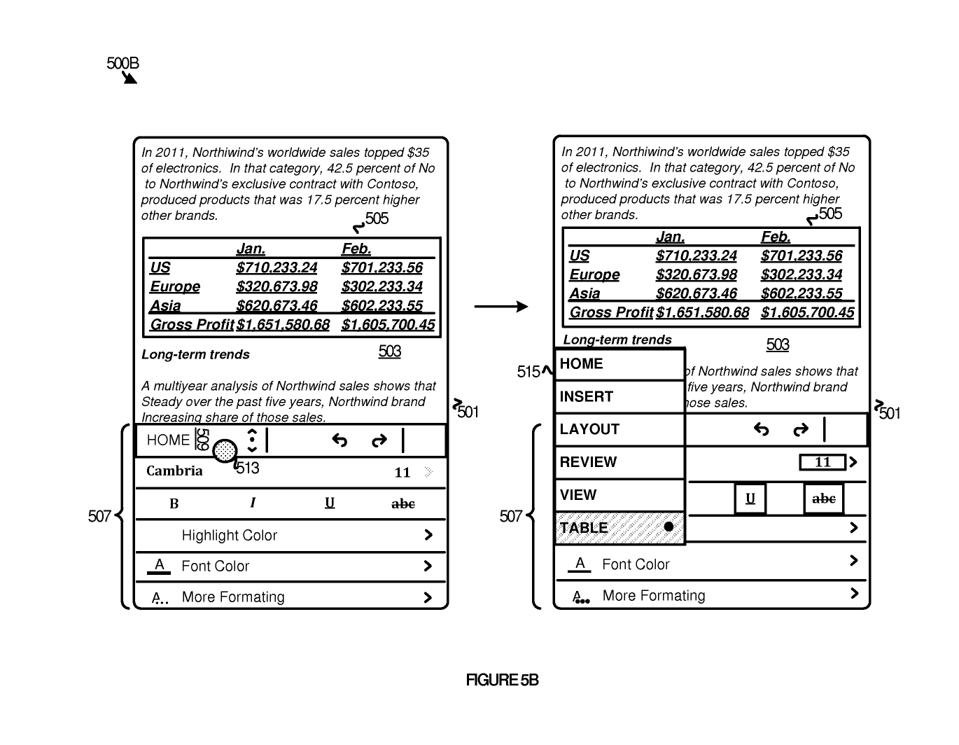

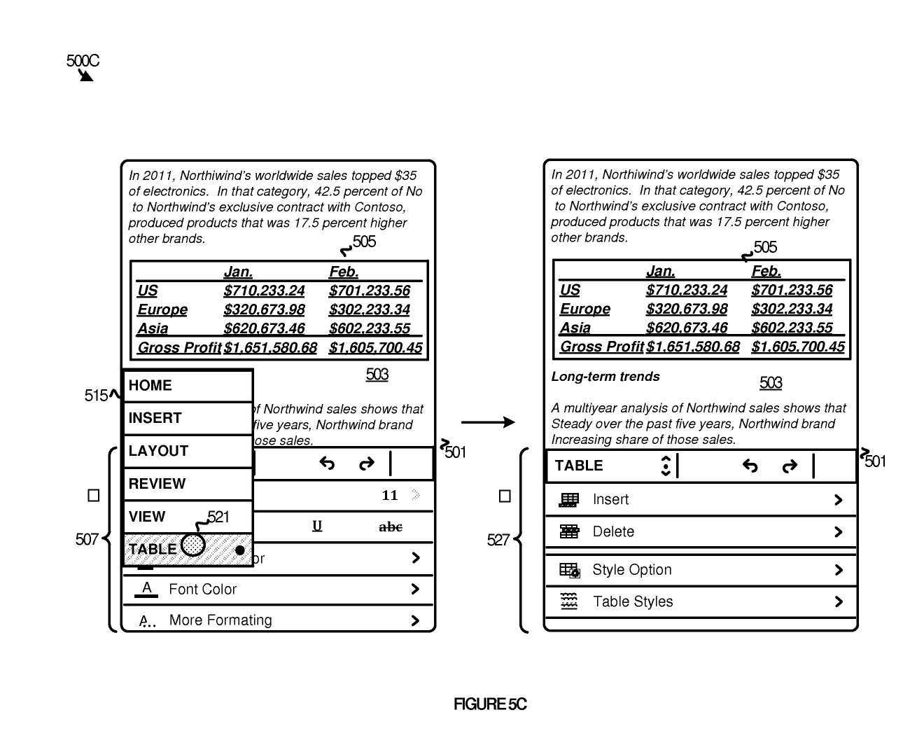

FIG. 5A illustrates a user interface progression 500A with respect to user interface 501. User interface 501 is representative of a user interface that may be produced by an application, such as a productivity application, an email application, or the like. User interface 501 includes canvas 503 in which content is displayed. The content includes a table 505 and text. User interface 501 also includes a feature menu 507.

Feature menu 507 includes various controls that a user may interact with in order to format text in canvas 503. Home button 509 is also included in feature menu 507 and is representative of a navigation element for navigation to a navigation menu.

In operation, the application that renders user interface 501 monitors user activity for any activity that may affect the presence of a contextual menu item in the navigation menu accessed by way of home button 509. An example of such triggering activity is selection 511, which is made with respect to table 505. Selection 511 of table 505 changes the visual appearance of table 505 so that a user knows it has been selected.

The appearance of home button 509 also changes to alert the user to the presence of a contextual menu item. The contextual menu item is present in the navigation menu off-screen because table 505 is selected. Selecting the contextual menu from the navigation screen would lead the user to a feature menu specific to tables. The change in the appearance to home button 509 is represented by a dot positioned between the vertical arrows in home button 509. The dot is a visual clue to the user that the navigation menu accessed through home button 509 includes a contextual menu element.

FIG. 5B illustrates a user interface progression 500B that may be encountered after a contextual menu element becomes available in a navigation element. In operation, home button 509 is displayed in its altered state. A selection 513 is made with respect to home button 509, which results in the progression of user interface 301 to a state in which a ribbon toolbar 515 is surfaced.

Ribbon toolbar 515 includes various menu elements and a contextual menu element, represented by the button labeled “table.” The table button is displayed with an appearance that distinguishes it from the other buttons in ribbon toolbar 515. In this example, the pattern fill and the presence of a dot alerts a user to the presence of the contextual menu item. It also informs the user that selecting the table buttons leads to controls and other tools that are specific to a table selected in a canvas. It may be appreciated that ribbon toolbar 515 is just one example of a navigational

In FIG. 5C, a user interface progression 500C is illustrated that may follow user interface progression 500B. In user interface progression 500C, a user makes a selection 521 of the table button in ribbon toolbar 515. The selection 521 drives a state change in user interface 501 whereby feature menu 507 is replaced by feature menu 527 corresponding to the table button. Feature menu 527 includes various controls and other features for controlling characteristics of table 505. Note that the table button in feature menu 527 also includes a dot between the vertical arrows to signify that contextual features are available in the menu.

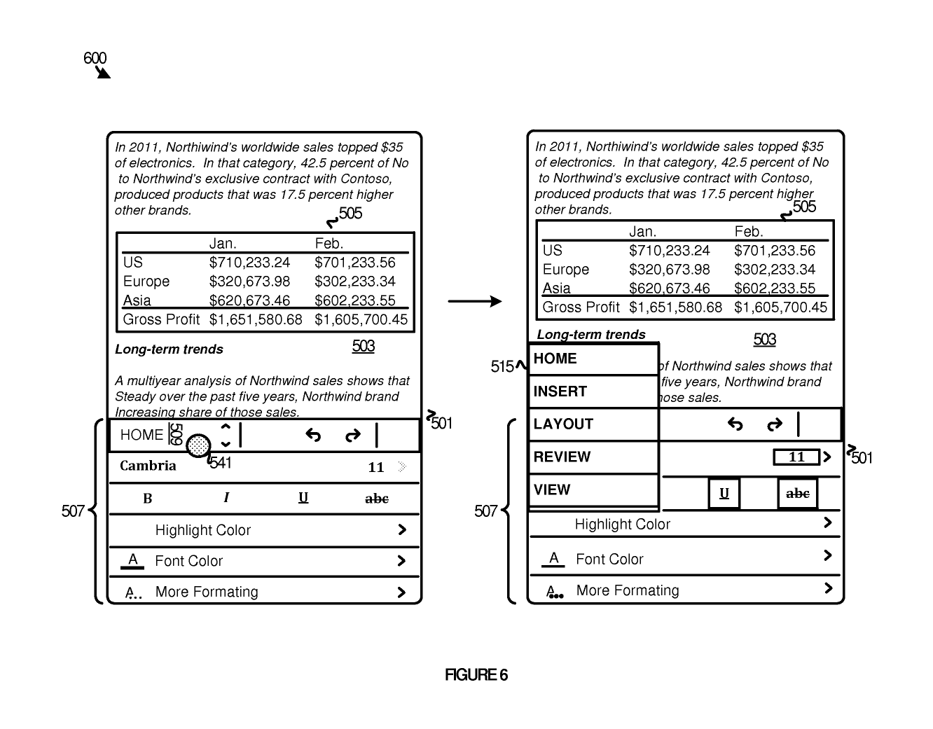

User interface progression 600, illustrated in FIG. 6, is representative of a progression that may occur when user activity does not trigger the presence of a contextual menu item in a navigation menu. In user interface progression 600, table 505 is not selected. Rather, a selection 541 is made with respect to home button 509. The selection of home button 509 surfaces ribbon toolbar 515. In this state, ribbon tool bar includes various buttons that correspond to feature menus, but it does not include a contextual menu element, such as

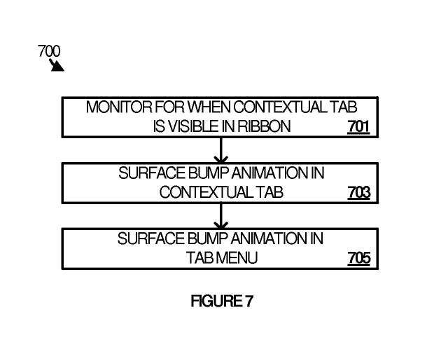

FIG. 7 illustrates a user interface process 700 in an implementation. User interface process 700 may be employed by a productivity application when rendering views to documents.

In operation, the application monitors for when a contextual tab is visible in a ribbon (step 701). When a tab is visible that is contextual, the application surfaces or renders a bump or animation in visual association with the contextual tab (step 703). When that or another contextual tab is selected, another bump or other such identifier is surfaced in the sub-menu for that tab in visual association with a name of the tab (step 705).

A technical effect that may be appreciated from the foregoing is an improvement in the user experience when interacting with ribbons and tab menus on small form factor devices, relative to desktop and laptop computers. For example, a user engaged with a productivity application on a mobile phone, tablet, or phablet will be alerted to the presence of a contextual tab in a tool bar menu, even though the menu is not yet visible to the user. The user will be reminded of its presence when viewing the tool bar menu. This may increase the speed with which a user navigates within a user interface and may lead to a reduction in navigational mistakes or other hindrances encountered by of the user.

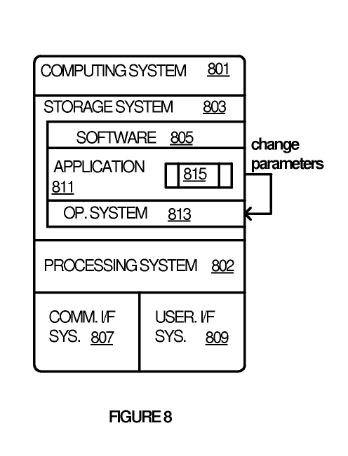

FIG. 8 illustrates computing system 801 that is representative of any system or collection of systems in which the various operational architectures, scenarios, and processes disclosed herein may be implemented. Examples of computing system 801 include, but are not limited to, smart phones, laptop computers, tablet computers, desktop computers, hybrid computers, gaming machines, virtual machines, smart televisions, smart watches and other wearable devices, as well as any variation or combination thereof. In other examples, other types of computers may be involved in the processes, including server computers, rack servers, web servers, cloud computing platforms, and data center equipment, as well as any other type of physical or virtual server machine, and any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes application 811 and operating system 813. Application 811 includes user interface process 815. Application 811 is representative of the applications discussed with respect to FIGS. 1-7. User interface process 815 is representative of the processes discussed with respect to FIGS. 1-7, including user interface process 200, user interface process 700, and the processes embodied in user interface progressions 300A, 300B, 300C, 400, 500A, 500B, 500C, and 600. When executed by processing system 802 to enhance user interface technology, software 805 directs processing system 802 to operate as described herein for at least the various processes, operational scenarios, and sequences discussed in the foregoing implementations. Computing system 801 may optionally include additional devices, features, or functionality not discussed for purposes of brevity.

In at least one implementation, application 811 renders a bump animation with respect to a navigation element by changing the parameters of the navigation element repeatedly. This may occur by making repeated calls operating system 813 to, for example, change the horizontal position of a navigation element. Operating system 813 receives the parameter changes and shifts the horizontal position of the navigation element back and for, in order to give the effect of a visual bump-out. Other mechanisms for affecting a bump animation are possible and may be considered within the scope of the disclosure.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 may be implemented in program instructions and among other functions may, when executed by processing system 802, direct processing system 802 to operate as described with respect to the various operational scenarios, sequences, and processes illustrated herein. For example, software 805 may include program instructions for implementing enhanced ribbon animations and related functionality.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components in addition to or that include user interface process 815. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to facilitate enhanced user interface technology, such as enhanced ribbon animations. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

It may be understood that computing system 801 is generally intended to represent a computing system or systems on which software 805 may be deployed and executed in order to implement enhanced user interface technology, such as enhanced ribbon animations. However, computing system 801 may also be suitable as any computing system on which software 805 may be staged and from where it may be distributed, transported, downloaded, or otherwise provided to yet another computing system for deployment and execution, or yet additional distribution.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface capable of presenting user interface progressions as discussed herein with respect to user interface 105, user interface 301, and user interface 501.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

While FIGS. 1-8 generally depict relatively few users and relatively few instances of service platforms, application platforms, applications, and services, it may be appreciated that the concepts disclosed herein may be applied at scale. For example, the ribbon processes disclosed herein could be deployed in support of any number of devices, users, data, applications, and instances thereof.

Certain inventive aspects may be appreciated from the foregoing disclosure, of which the following are various examples.

### Example 1

An apparatus comprising: one or more computer readable storage media; and program instructions stored on the one or more computer readable that, when executed by a processing system, directs the processing system to at least: present a user interface to an application comprising a canvas and a navigation element that, when selected, surfaces a navigation menu that includes a plurality of menu elements selectable to navigate to a plurality of feature menus; monitor for activity that affects a presence in the plurality of menu elements of a contextual menu element for navigating to a contextual feature menu; and when the activity occurs, modify an appearance of the navigation element to indicate the presence of the contextual menu element.

### Example 2

The apparatus of Example 1 wherein the program instructions, responsive to a selection of the navigation element when the contextual menu element is present in the navigation menu, further direct the processing system to present the navigation menu in the user interface and to modify an appearance of the contextual menu element to visually distinguish the contextual menu element from other menu elements in the plurality of menu elements.

### Example 3

The apparatus of Examples 1-2 wherein the program instructions, responsive to a selection of the contextual menu element, direct the processing system to present the contextual feature menu and to modify an appearance of another navigation element in the contextual feature menu to visually represent a presence of contextual controls.

### Example 4

The apparatus of Examples 1-3 further comprising the processing system that executes the program instructions, wherein the navigation menu comprises a ribbon toolbar, and wherein each of the plurality of menu elements comprises a graphical tab selectable to navigate to a corresponding one of the plurality of feature menus.

### Example 5

The apparatus of Examples 1-4 wherein to modify the appearance of the navigation element, the program instructions direct the processing system to shift the navigation element horizontally from an initial position in the user interface and to return the navigation element to the initial position.

### Example 6

The apparatus of Examples 1-5 wherein the program instructions comprise the application and wherein, to shift the navigation element horizontally from the initial position in the user interface and to return the navigation element to the initial position, the application directs the processing system to make a plurality of calls into an operating system component to shift a horizontal display parameter of the navigation element from an initial value to a subsequent value, and to return the horizontal display parameter to the initial value.

### Example 7

The apparatus of Examples 1-6 wherein to modify the appearance of the navigation element, the program instructions further direct the processing system to surface an instance of a symbol in the navigation element.

### Example 8

The apparatus of Examples 1-7 wherein to modify the appearance of the contextual menu element to visually distinguish the contextual menu element from the other menu elements in the plurality of menu elements, the program instructions direct the processing system to surface another instance of the symbol in the contextual menu element.

### Example 9

An apparatus comprising: one or more computer readable storage media; and program instructions stored on the one or more computer readable storage media and comprising an application that, when executed by a processing system, directs the processing system to at least: surface a bump animation to indicate the presence of a contextual tab in a ribbon; and when a tab is selected that is contextual, surface another bump animation to indicate that the tab is contextual.

### Example 10

The apparatus of Example 9 further comprising the processing system operatively coupled with the one or more computer readable storage media to read and execute the program instructions, wherein the application comprises a document productivity application.

### Example 11

The apparatus of Examples 9-10 wherein the program instructions further direct the processing system to surface the contextual tab in the ribbon in a manner that distinguishes the contextual tab from other, non-contextual tabs in the ribbon.

### Example 12

The apparatus of Examples 9-11 wherein the program instructions further direct the processing system to monitor for activity to occur in a user interface to the application that triggers the presence of the contextual tab in the ribbon.

### Example 13

A method for enhancing user interfaces to applications, the method comprising: presenting a user interface to an application comprising a canvas and a navigation element that, when selected, surfaces a navigation menu that includes a plurality of menu elements selectable to navigate to a plurality of feature menus; monitoring for activity that affects a presence in the plurality of menu elements of a contextual menu element for navigating to a contextual feature menu; and when the activity occurs, modifying an appearance of the navigation element to indicate the presence of the contextual menu element.

### Example 14

The method of Example 13 wherein the program instructions, responsive to a selection of the navigation element when the contextual menu element is present in the navigation menu, further direct the processing system to present the navigation menu in the user interface and to modify an appearance of the contextual menu element to visually distinguish the contextual menu element from other menu elements in the plurality of menu elements.

### Example 15

The method of Examples 13-14 wherein, responsive to a selection of the contextual menu element, presenting the contextual feature menu and modifying an appearance of another navigation element in the contextual feature menu to visually represent a presence of contextual controls.

### Example 16

The method of Examples 13-15 wherein the navigation menu comprises a ribbon toolbar, and wherein each of the plurality of menu elements comprises a graphical tab selectable to navigate to a corresponding one of the plurality of feature menus.

### Example 17

The method of Examples 13-16 wherein modifying the appearance of the navigation element comprises shifting the navigation element horizontally from an initial position in the user interface and returning the navigation element to the initial position.

### Example 18

The method of Examples 13-17 wherein shifting the navigation element horizontally from the initial position in the user interface and returning the navigation element to the initial position comprises the application calling into an operating system component to shift a horizontal display parameter of the navigation element from an initial value to a subsequent value and to return the horizontal display parameter to the initial value.

### Example 19

The method of Examples 13-18 wherein modifying the appearance of the navigation element further comprises surfacing an instance of a symbol in the navigation element.

### Example 20

The method of Examples 13-19 wherein modifying the appearance of the contextual menu element to visually distinguish the contextual menu element from the other menu elements in the plurality of menu elements comprises surfacing another instance of the symbol in the contextual menu element.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. An apparatus comprising:
one or more computer readable storage media; and
program instructions stored on the one or more computer readable storage media that, when executed by a processing system, direct the processing system to at least:
present a user interface to an application comprising a canvas and a navigation element that, when selected, surfaces a navigation menu that includes a plurality of menu elements selectable to navigate to a plurality of feature menus;
monitor for activity that affects a presence in the plurality of menu elements of a contextual menu element for navigating to a contextual feature menu; and
when the activity occurs, modify an appearance of the navigation element to indicate the presence of the contextual menu element.

2. The apparatus of claim 1 wherein the program instructions, responsive to a selection of the navigation element when the contextual menu element is present in the navigation menu, further direct the processing system to present the navigation menu in the user interface and to modify an appearance of the contextual menu element to visually distinguish the contextual menu element from other menu elements in the plurality of menu elements.

3. The apparatus of claim 2 wherein the program instructions, responsive to a selection of the contextual menu element, direct the processing system to present the contextual feature menu and to modify an appearance of another navigation element in the contextual feature menu to visually represent a presence of contextual controls.

4. The apparatus of claim 2 further comprising the processing system that executes the program instructions, wherein the navigation menu comprises a ribbon toolbar, and wherein each of the plurality of menu elements comprises a graphical tab selectable to navigate to a corresponding one of the plurality of feature menus.

5. The apparatus of claim 4 wherein to modify the appearance of the navigation element, the program instructions direct the processing system to shift the navigation element horizontally from an initial position in the user interface and to return the navigation element to the initial position.

6. The apparatus of claim 5 wherein the program instructions comprise the application and wherein, to shift the navigation element horizontally from the initial position in the user interface and to return the navigation element to the initial position, the application directs the processing system to make a plurality of calls into an operating system component to shift a horizontal display parameter of the navigation element from an initial value to a subsequent value, and to return the horizontal display parameter to the initial value.

7. The apparatus of claim 5 wherein to modify the appearance of the navigation element, the program instructions further direct the processing system to surface an instance of a symbol in the navigation element.

8. The apparatus of claim 7 wherein to modify the appearance of the contextual menu element to visually distinguish the contextual menu element from the other menu elements in the plurality of menu elements, the program instructions direct the processing system to surface another instance of the symbol in the contextual menu element.

9. An apparatus comprising:
one or more computer readable storage media; and
program instructions stored on the one or more computer readable storage media and comprising an application that, when executed by a processing system, direct the processing system to at least:
surface a bump animation to indicate the presence of a contextual tab in a ribbon; and
when a tab is selected that is contextual, surface another bump animation to indicate that the tab is contextual.

10. The apparatus of claim 9 further comprising the processing system operatively coupled with the one or more computer readable storage media to read and execute the program instructions, wherein the application comprises a document productivity application.

11. The apparatus of claim 9 wherein the program instructions further direct the processing system to surface the contextual tab in the ribbon in a manner that distinguishes the contextual tab from other, non-contextual tabs in the ribbon.

12. The apparatus of claim 9 wherein the program instructions further direct the processing system to monitor for activity to occur in a user interface to the application that triggers the presence of the contextual tab in the ribbon.

13. A method for enhancing user interfaces to applications, the method comprising:
presenting a user interface to an application comprising a canvas and a navigation element that, when selected, surfaces a navigation menu that includes a plurality of menu elements selectable to navigate to a plurality of feature menus;
monitoring for activity that affects a presence in the plurality of menu elements of a contextual menu element for navigating to a contextual feature menu; and
when the activity occurs, modifying an appearance of the navigation element to indicate the presence of the contextual menu element.

14. The method of claim 13 wherein the program instructions, responsive to a selection of the navigation element when the contextual menu element is present in the navigation menu, further direct the processing system to present the navigation menu in the user interface and to modify an appearance of the contextual menu element to visually distinguish the contextual menu element from other menu elements in the plurality of menu elements.

15. The method of claim 14 wherein, responsive to a selection of the contextual menu element, presenting the contextual feature menu and modifying an appearance of another navigation element in the contextual feature menu to visually represent a presence of contextual controls.

16. The method of claim 14 wherein the navigation menu comprises a ribbon toolbar, and wherein each of the plurality of menu elements comprises a graphical tab selectable to navigate to a corresponding one of the plurality of feature menus.

17. The method of claim 16 wherein modifying the appearance of the navigation element comprises shifting the navigation element horizontally from an initial position in the user interface and returning the navigation element to the initial position.

18. The method of claim 17 wherein shifting the navigation element horizontally from the initial position in the user interface and returning the navigation element to the initial position comprises the application calling into an operating system component to shift a horizontal display parameter of the navigation element from an initial value to a subsequent value and to return the horizontal display parameter to the initial value.

19. The method of claim 17 wherein modifying the appearance of the navigation element further comprises surfacing an instance of a symbol in the navigation element.

20. The method of claim 19 wherein modifying the appearance of the contextual menu element to visually distinguish the contextual menu element from the other menu elements in the plurality of menu elements comprises surfacing another instance of the symbol in the contextual menu element.
